(19) United States
(12) Patent Application Publication
(10) Pub. No.: US 2010/0049612 A1
(43) Pub. Date: Feb. 25, 2010

(54) CONTENT PROVISION, DISTRIBUTION, REGISTRATION, MANAGEMENT, AND REPRODUCTION

(75) Inventors: Norishige Morimoto, Tokyo (JP); Katashi Nagao, Kanagawa-ken (JP); Seiji Kobayashi, Kanagawa-ken (JP)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/543,939

(22) Filed: Aug. 19, 2009

Related U.S. Application Data
(62) Division of application No. 10/074,786, filed on Feb. 12, 2002, now abandoned.

(30) Foreign Application Priority Data
Feb. 20, 2001 (JP) 200144187

(51) Int. Cl. G06Q 30/00; G06Q 20/00

(52) U.S. Cl. 705/14.66; 705/14.69

(57) ABSTRACT

The present invention provides methods, systems and apparatus for aggressive business content use and control purposes, using media properties that powerfully convey content. An example embodiment includes an advertisement and/or other content distribution system comprising: a content provider system, for providing for a user terminal content to which an identifier has been added; the user terminal, for receiving the content, via a network, from the content provider system, and for identifying and outputting, to the network, the identifier added to the content; an advertiser system, for the distribution to the user terminal, based on the identifier output by the user terminal, of a predetermined advertisement via the network; and an agent server system, for managing the identifier added to the content, and for employing the identifier, output by the user terminal, to transmit an advertisement distribution trigger to the advertiser system for the distribution of the predetermined advertisement.

### CROSS REFERENCE TO RELATED APPLICATION

This application is a divisional of U.S. patent application Ser. No. 10/074,786, filed Feb. 12, 2002 the entire content and disclosure of which is incorporated herein by reference.

### FIELD OF THE INVENTION

The present invention relates to additional information distribution. More particularly it relates to distributing additional information using the free distribution of digital content.

### BACKGROUND

Digital content is a commodity that can be freely exchanged by anyone via a network, such as the Internet, because of the ease with which it can be stored, copied and transmitted. Relatively recently, as Internet use continues to grow, there has been a great increase in the speed at which data travels over communication lines, until today, not only music data but also much larger data packages, such as those for video data, can be rapidly exchanged. Meanwhile, in Japan a reappraisal of communication fees and access fees is producing dramatic results, while an infrastructure permitting uninterrupted connections is gradually being established. As everyone knows, in this environment the practice of accessing and downloading free popular content available via the Internet has expanded explosively, and momentarily will be common throughout the world.

There are well known examples of systems established for the distribution of free content. These systems are based on P2P file programs that facilitate the exchange and use in common of files via the Internet, without requiring the intervention of a central server. With these systems, music available at the sites of users registered with a network can be downloaded for free from anywhere in the world.

However, these systems do not incorporate mechanisms for managing copyrights or right of use of registered content, data recorded on CDs, for example, the copying of which is inhibited may be uploaded. And in actuality, most users acquiring content in this manner maybe guilty of copyright infringement, regardless of whether they are aware of it or not.

In a further attempt to resolve the problem presented by the provision of free content, a move has been made to provide a technique whereby compensation would be paid musicians whose music is distributed for free. In one example, a technique allows a content owner to enter a voice advertisement in an MP3 file, for which a standardized compression system called MPEG-1 Audio Layer-III is used. This technique is intended for use in the preparation of music files for which benefits are forthcoming even when the music is distributed for free, and the development of a system whereby royalty payments would be made to musicians, publishing companies and record companies.

The intent of this technique is the inclusion in content of advertisements that would consistently garner sponsorship fees that could be shared among composers, etc. However, were this idea adopted, an advertisement could be inserted into content only one time, and since the advertisement could not be rewritten, it would be monotonously reproduced, no matter how many years had elapsed. In addition, it would be difficult to track usage frequencies, and advertisers would have to pay usage fees regardless of how effective their advertisements were. In this case, the assessment of high advertisement fees would not justified, and thus, the return afforded the persons who provided the content would be uncertain. Further, since a fixed, specific format would be used, the content could not be reproduced by portable players commonly available on the market.

### SUMMARY OF THE INVENTION

To resolve the above technical problems, it is one aspect of the present invention to provide a system for using, for aggressive business advertising purposes, the properties of media that powerfully convey content.

It is another aspect of the present invention to resolve the problems presented by the illegal use of downloading services for providing free content and to devise a legal system.

It is an additional aspect of the present invention to flexibly set up added information, such as advertisements introduced by the same content, and an effective time for the presentation of the additional information.

It is a further aspect of the present invention to provide a system that ensures the equitable sharing with content providers of rewards consonant with how helpful content is when used as an advertisement and/or other content medium.

To achieve the above aspects, according to the present invention, an advertising or other content distribution system employs a so-called P2P system for the distribution of free content, and provides a service for the distribution of advertisement and/or other content to users who desire to acquire the free content. That is, according to a first example embodiment of the invention, an advertisement and/or other content distribution system comprises: a content provider system, for providing for a user terminal content to which an identifier has been added; a user terminal, for receiving the content, via a network, from the content provider system, and for identifying and outputting, to the network, the identifier added to the content; and an advertisement and/or other content provider system, for the distribution to the user terminal, based on the identifier output by the user terminal, of a predetermined advertisement and/or other content via the network.

In some cases, the advertisement and/or other content distribution system further comprises: an agent server system, for managing the identifier added to the content, wherein the agent server system employs the identifier, output by the user terminal, to transmit an advertisement and/or other content distribution trigger to the advertisement and/or other content provider system for the distribution of the predetermined advertisement and/or other content. This configuration is preferable in that an advertisement and/or other content can be introduced systemwide using the same content, and an effective propagation period for the advertisement and/or other content can be flexibly set.

According to another aspect of the invention, a content registration/management system comprises: content registration request reception means, for receiving a request for content registration from a content provider that provides content; identifier provision means, for setting an identifier, based on the request that is received, to be added to the content that is to be provided a user terminal, and for providing the identifier to a content provider; and a content ledger database, for storing information related to the identifier provided the content provider.

In an example embodiment, a particular content registration/management system comprises: identifier reception means, for receiving from a user terminal an identifier provided for the user terminal; and content reproduction information collection means, for collecting, based on the reception of the identifier, information related to the reproduction of content, such as a count used for calculating the frequency whereat the identifier is received. With this configuration, it is preferable that a count be used to represent the contribution level of the content as an advertisement and/or other content medium.

Further, the content registration/management system often comprises: an advertisement and/or other content ledger database for registering a list of contents that can be used as advertisement and/or other content media; and notification means for searching the advertisement and/or other content ledger database based on the received identifier, and for transmitting an advertisement and/or other content distribution request to an advertiser.

According to an additional aspect of the invention, an advertisement and/or other content distribution management system is provided for managing the distribution of an advertisement and/or other content to a user terminal. In an example embodiment the system comprises: an advertisement and/or other content ledger database, for the storage therein of a list to which content used as an advertisement and/or other content medium for the advertisement and/or other content and information concerning an advertisement and/or other content distribution site for disseminating the advertisement and/or other content when the content is reproduced; reception means, for receiving a content ID output by the user terminal when the content is reproduced; search means, for performing a search, based on the content ID, of the advertisement and/or other content ledger database for the predetermined advertisement and/or other content distribution site; and notification means, for issuing to the predetermined advertisement and/or other content distribution site, when found, an advertisement and/or other content distribution request.

The reception means receives address information for the user terminal, and the notification means transmits the address information to the advertisement and/or other content distribution site. As a result, the advertisement and/or other content distribution destination is manifested, and can contribute to an increase in the effect produced by advertising through the distribution, for example, of an advertisement and/or other content that is appropriate for the specific user.

According to a further aspect of the invention, a content provider system comprises: storage means, for storing pertinent content and a corresponding content ID for identifying the pertinent content; reception means, for receiving a content download request from a user terminal; and content provision means, for reading, based on the content downloading request, the pertinent content and the corresponding content ID from the storage means, and for providing for the user terminal the pertinent content and the content ID.

The storage means is used to store a content with a content ID being embedded. Further, before the content is provided for the user terminal, the content ID may be added to the content. That is, in the storage means the content and the content ID may be separately stored, or the content may be stored with the content ID being embedded.

In a further example embodiment, the content provider system further comprises: registration request output means, for outputting a registration request to an agent server that manages a content ID; and content ID reception means, for receiving, based on the registration request, the content ID from the agent server. The agent server can also receive a content ID embedding tool, or a service for embedding a content ID.

According to a still further aspect and example embodiment of the invention, a user terminal comprises: content reproduction means, for reproducing content wherein a content ID has been embedded; detection means, for detecting the embedded content ID when the content is to be reproduced; notification means, for transmitting the detected content ID to a predetermined server via a network; and advertisement and/or other content data reception means for receiving from a predetermined advertisement and/or other content distribution site, via a network, advertisement and/or other content data corresponding to the content ID. During the reproduction of the content, the content reproduction means can output received advertisement and/or other content data having a pop-up form, for example.

According to one more aspect of the invention, an advertisement and/or other content distributer system comprises: registration request output means, for outputting an advertisement and/or other content registration request to an agent server system that manages an identifier included in predetermined content; address information reception means, for receiving address information for a user terminal that reproduces content; and advertisement and/or other content data distribution means, for distributing advertisement and/or other content data that is output to the user terminal for content reproduction.

Further, the advertisement and/or other content distributor system also comprises: bill reception means, for receiving from the agent server system a bill corresponding to the frequency whereat content is reproduced; and advertisement and/or other content fee payment means, for paying an advertisement and/or other content fee in accordance with the bill. This configuration is generally preferable because specific charging can be performed for an advertisement and/or other content distributer in accordance with an obtained profit. In addition, with this arrangement, compensation corresponding to the contribution made by content can be distributed to the content provider.

The present invention can be implemented as a content reproduction program that permits a computer to reproduce content in which a content ID is embedded, or as a storage medium on which a computer stores a computer-readable program. The content reproduction program permits a computer to perform: a function (process) for detecting a content ID embedded in content; a function (process) for transmitting the content ID via a network; and a function (process) for, before content reproduction, outputting advertisement and/or other content data, based on the content ID, that are received via a network and have a predetermined form for displaying an advertisement and/or other content, for example, while interacting with content. The storage medium can be a CD-ROM, a DVD, memory, or a hard disk on which a computer stores a computer-readable program.

### BRIEF DESCRIPTION OF THE DRAWINGS

FIG. 1 is a schematic diagram for explaining an advertisement and/or other content distribution system according to one embodiment of the present invention.

FIG. 2 is a block diagram showing the configuration of an agent server system 10.

FIGS. 3A and 3B are diagrams showing example data stored in a content ledger DB 11 and an advertisement and/or other content ledger DB 12.

FIG. 4 is a block diagram showing the configuration of a content provider system 30.

FIG. 5 is a block diagram showing the configuration of a user terminal 50.

FIG. 6 is a flowchart showing the processing performed by a reproduction device (reproduction software) 55 having a content ID detection function.

FIG. 7 is a block diagram showing the configuration of an advertiser system 70.

### DESCRIPTION OF THE SYMBOLS

10: Agent server system
11: Content ledger DB
12: advertisement and/or other content ledger DB
13: Content registration/ledger preparation unit
14: Content ledger search unit
15: advertisement and/or other content registration/ledger preparation unit
16: advertisement and/or other content ledger search unit
17: advertisement and/or other content distribution requesting unit
18: Content reproduction count aggregating unit
19: advertisement and/or other content income distribution unit
21: Content registration request reception unit
22: Content ID transmission unit
23: advertisement and/or other content registration request reception unit
24: Registration notification unit
25: Search request reception unit
26: Search result transmission unit
27: Content ID reception unit
30: Content provider system
31: Content DB
32: Content registration requesting unit
33: Content ID reception unit
34: Content ID embedding unit
35: Downloading request receiving unit
36: ID-added content disclosing unit
50: User terminal
51: Content search requesting unit
52: Search results reception unit
53: Content download requesting unit
54: Content reception unit
55: Reproduction device (reproduction software) having a content ID detection function
56: ID detection compatible player downloading unit
57: Content ID notification unit
58: User ID notification unit
59: Advertisement and/or other content data reception unit
70: Advertiser system (advertisement and/or other content distributer (provider) system)
71: Advertisement and/or other content DB
72: advertisement and/or other content preparation unit
73: Registration requesting unit
74: Registration notification reception unit
75: Addressee user ID notification reception unit
76: advertisement and/or other content data distribution unit.

### DESCRIPTION OF THE INVENTION

The present invention provides, methods, systems and apparatus for using, for aggressive business advertising purposes, the properties of media that powerfully convey content. The invention also allows one to resolve the problems presented by the illegal use of downloading services for providing free content and to devise a legal system. It also provides one to flexibly set up added information, such as advertisements introduced by the same content, and an effective time for the presentation of the additional information. It further provides systems that enable equitable sharing with content providers of rewards consonant with how helpful content is when used as an advertisement and/or other content medium.

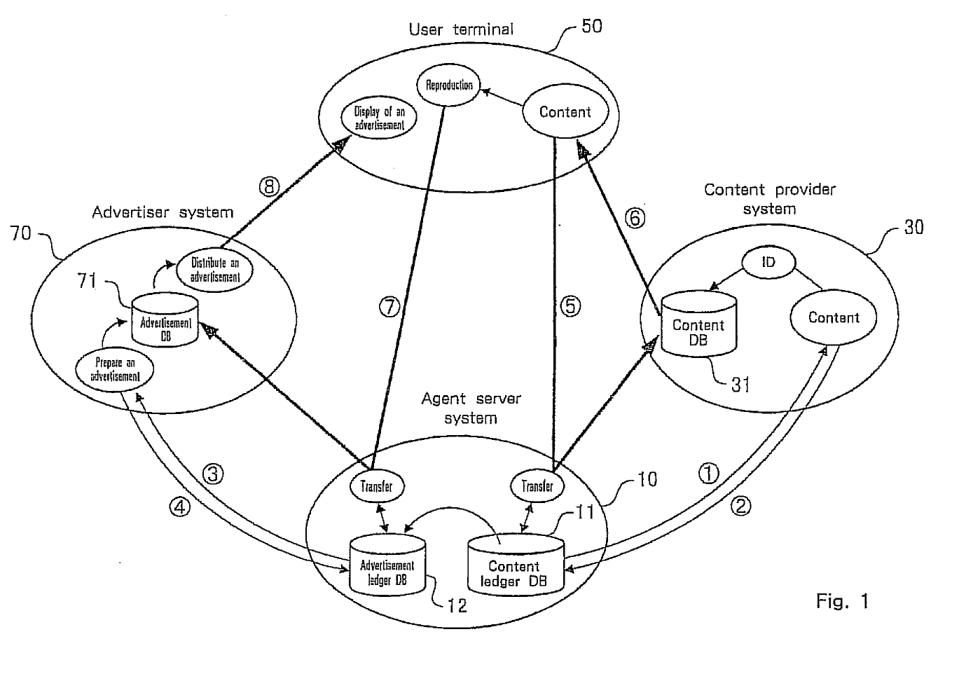

An example embodiment of the present invention will now be described in detail while referring to the accompanying drawings. FIG. 1 is a schematic diagram for explaining the configuration of an advertisement and/or other content distribution system according to the embodiment. In this embodiment, the system comprises: an agent server system 10, which contributes greatly to the tie-up of content and an advertisement and/or other content; a content provider system 30, for providing digital content; a user terminal 50, for downloading and reproducing digital content that is provided and displaying the content and an advertisement and/or other content; and an advertiser system (advertisement and/or other content distributer (provider) system) 70 for distributing an advertisement and/or other content to the user terminal 50, all of which are connected via a network, such as the Internet. In this embodiment, with this configuration, the registration of content, such as music or video, the downloading of content to the user terminal 50, the use of content and the reproduction of an advertisement and/or other content, and the creation and the preparation of a charge for an advertisement and/or other content are performed. The above described components (or the systems) can be constituted by a single computer, or by multiple computers. The content provider system 30, the agent server system 10 and the advertiser system 70 may be constituted by individual entities, or two or all of them may be combined and be constituted by the same entity.

The agent server system 10 is related to the addition of a registration number (content ID), an identifier, to digital content provided by the content provider system 30. Further, the agent server system 10 transmits a registration notification in response to a registration request issued by the advertiser system 70, and provides for the advertiser system 70 information concerning a user who is an addressee. To implement these functions, the agent server system 10 includes a content ledger DB (database) 11, for storing a content management ledger, and an advertisement and/or other content ledger DB 12, for storing an advertisement and/or other content management ledger.

The content provider system 30 includes a content DB 31, for storing digital content to be provided for the user terminal 50. A content ID is embedded in the digital content that is to be stored in the content DB 31. It should be noted, however, that the content and the content ID may be stored separately in the content DB 31, and before transmission of the content to the user terminal 50, the content ID may be embedded in the content.

The advertiser system 70 has an advertisement and/or other content DB 71 for storing advertisement and/or other content information to be distributed to the user terminal 50. The “advertiser” may be replaced by the “advertisement provider” or the “advertisement distributer”. The advertiser system 70 can be constituted as an additional information provision site for providing additional information for the content in addition to the common advertisement and/or other content. The additional information to be provided can include information used to increase the resolution or to improve the tone quality of content that is first provided by the content provider system 30.

To easily understand the advertisement and/or other content distribution system of this embodiment, the processing performed by the individual components of this system will be briefly explained while referring to FIG. 1. First, the agent server system 10 provides a content ID embedding tool or an embedding agent service for the content provider system 30 (arrow \textcircled{1}). While the content provider system 30 issues a digital content registration request to the agent server system 10 (arrow \textcircled{2}). The agent server system 10 also provides an advertisement and/or other content preparation tool or a preparation agent service for the advertiser system 70 (arrow \textcircled{3}). While the advertiser system 70 issues, to the agent server system 10, an advertisement and/or other content request and a request for the registration of a site that distributes an advertisement and/or other content (arrow \textcircled{4}).

Thereafter, the user terminal 50 issues an inquiry to the agent server system 10 and searches for preferred content (arrow \textcircled{5}), and then downloads the preferred content from the content provider system 30 (arrow \textcircled{6}). When the content is reproduced by the user terminal 50, the user terminal 50 transmits a content ID to the agent server system 10, which in turn transmits the content ID to the advertiser system 70 (arrow \textcircled{7})). Based on the received content ID, the advertiser system 70 distributes the advertisement and/or other content information stored in the advertisement and/or other content DB 71 to the user terminal 50 (arrow \textcircled{8}).

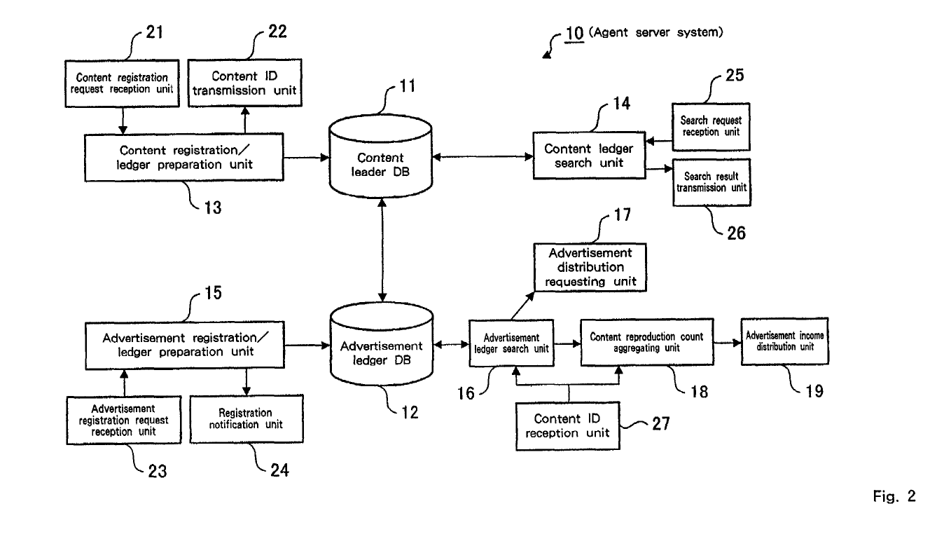

The configurations of the individual systems will now be described in detail. FIG. 2 is a block diagram illustrating the configuration of the agent server system 10. The agent server system 10 includes: a content registration request reception unit 21, for receiving a registration request from the content provider system 30, the owner of digital content; a content registration/ledger preparation unit 13, for registering content and for preparing a content ledger; and a content ID transmission unit 22, for transmitting the registration numbers (content IDs) of registered content to the content provider system 30. The information generated by the content registration/ledger preparation unit 13 is stored in the content ledger DB 11. The agent server system 10 further includes: a search request reception unit 25, for receiving a search request from the user terminal 50; a content ledger search unit 14, for searching for content preferred by a user based on the information stored in the content ledger DB 11, in accordance with the received request; and a search result transmission unit 26, for transmitting the search results to the user terminal 50.

The agent server system 10 also includes: an advertisement and/or other content registration request reception unit 23, for receiving a registration request from the advertiser system 70; an advertisement and/or other content registration/ledger preparation unit 15, for registering a site that distributes advertisements and/or other contents; and a registration notification unit 24, for transmitting to the advertiser system 70 the registered information, which is stored in the advertisement and/or other content ledger DB 12 by the advertisement and/or other content registration/ledger preparation unit 15. The agent server system 10 further includes: a content ID reception unit 27 for receiving the content ID from the user terminal 50, an advertisement and/or other content ledger search unit 16, for searching the advertisement and/or other content ledger DB 12 by referring to the received content ID; and an advertisement and/or other content distribution requesting unit 17 for transmitting to the advertiser system 70 a user ID for the distribution addressee. Further, the system 10 includes: a content reproduction count aggregating unit 18, for counting the number of advertisement and/or other content request triggers issued based on the content ID obtained by the content ID reception unit 27, and for transmitting the aggregate to the advertiser system 70 as a reproduction count. Further, an advertisement and/or other content income distribution unit 19 distributes advertisement and/or other content fees to the content provider system 30 based on the results obtained by the content reproduction count aggregating unit 18.

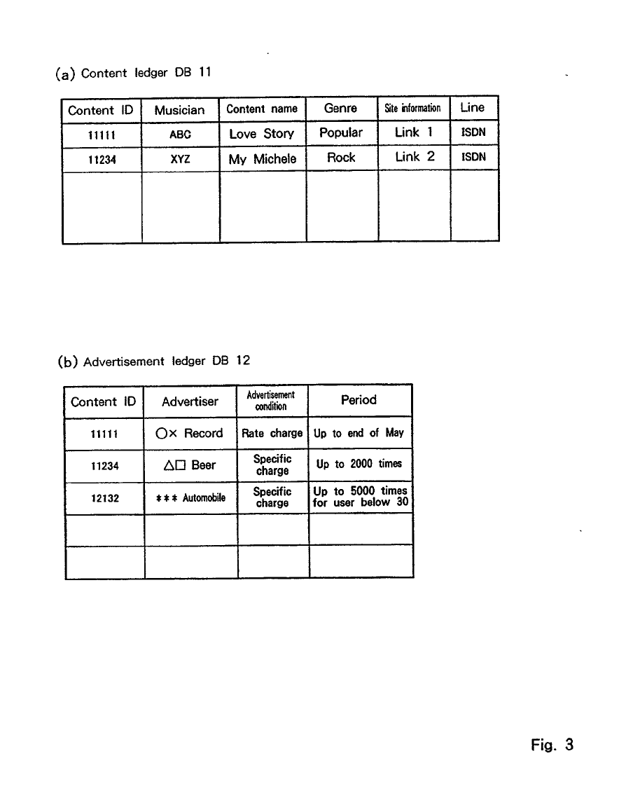

FIGS. 3A and 3B are diagrams showing example data stored in the content ledger DB 11 and the advertisement and/or other content ledger DB 12. As is shown in FIG. 3A, content IDs, musicians' names, content names, content types, site information and line information are stored in the content ledger DB 11. In other words, the name of a content that can be downloaded and the link to the site whereat the content is available are prepared. As is shown in FIG. 3B, content IDs, advertiser information, advertisement and/or other content conditions and advertisement and/or other content periods are stored in the advertisement and/or other content ledger DB 12. In other words, a list of the contents that can be used as advertisement and/or other content media, and the sites of advertisers that transmit (re-direct) triggers in response to this are shown. The charge types in this embodiment are a rate charging system that is effective for a specific period of time, and a specific charging system that charges a fee in accordance with the number of triggers issued in response to advertisement and/or other content requests. For the specific charging system, a satisfactory amount of money consonant with received profit is paid, and a charge is determined in accordance with the results obtained by the content reproduction count aggregating unit 18. However, it is preferable that an upper limit be set to prevent payments from soaring. For example, as is shown in FIG. 3B, a predetermined condition, such as “up to 2000 times” or “up to 5000 times for users under 30”, when user information is available, can be employed to set a limit. While for the rate charging system, a contract can be entered into that provides for trigger information for specified content to be transmitted to the advertiser system 70 for a specific period of time.

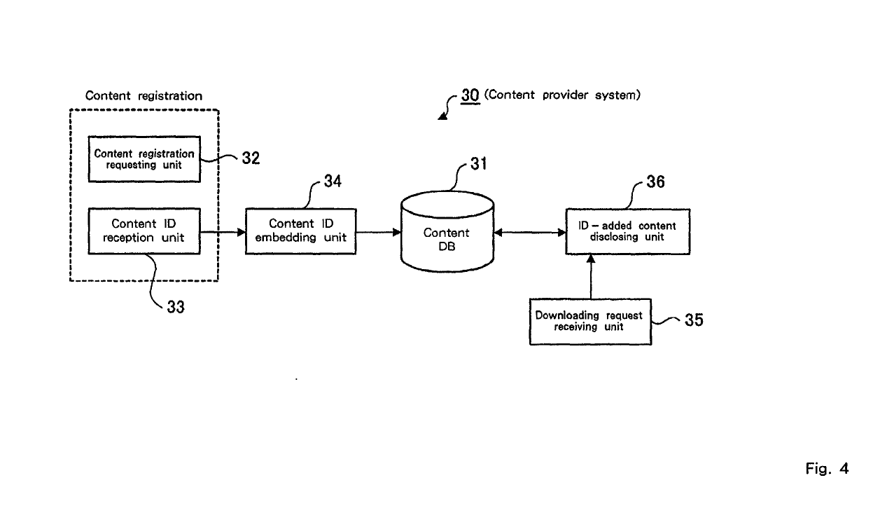

FIG. 4 is a block diagram showing the configuration of the content provider system 30. This system 30 includes, to fulfill content registration functions, a content registration requesting unit 32, for issuing a registration request to the agent server system 10; and a content ID reception unit 33, for receiving an added registration number from the agent server system 10. The system 30 further includes a content ID embedding unit 34, for embedding an obtained content ID in digital content. The digital content in which the content ID is embedded is then stored in a content DB 31. In this manner, the agent server system 10 adds a registration number to the content for which the content registration requesting unit 32 has requested the registration, and the same registration number is also added to an electronic watermark, for example, or a content header. The addition of the content ID is performed by the content ID embedding unit 34 of the content provider system 30 that received the tool from the agent server system 10. However, this embedding operation may be performed by the agent server system 10.

The content provider system 30 includes: a downloading request receiving unit 35, for receiving a digital content download request from the user terminal 50; and an ID-added content disclosing unit 36, for providing for the user terminal 50, upon the reception of the request by the downloading request receiving unit 35, content accompanied by an ID. In this manner, the digital content is stored at the site of the content provider, while a download request from a common user is waited for.

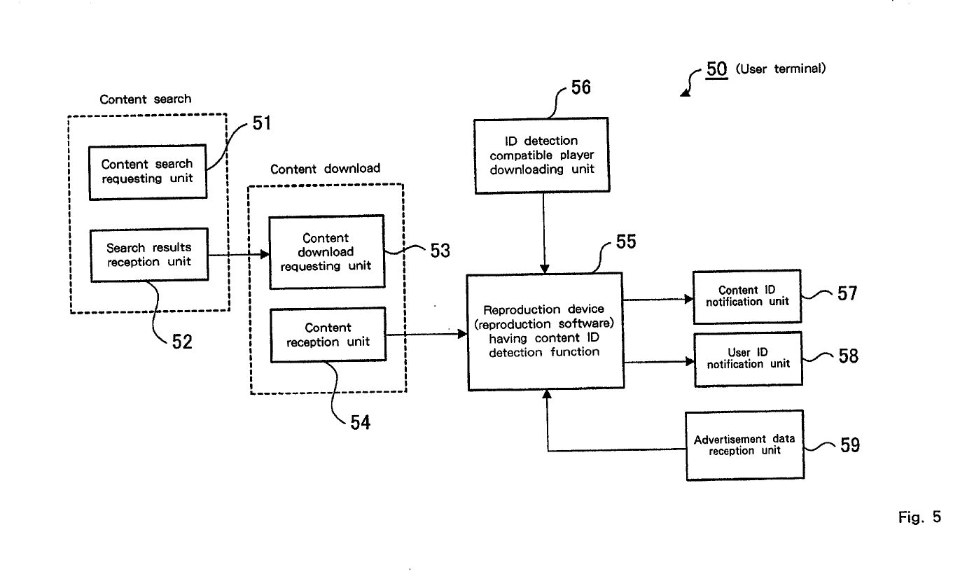

FIG. 5 is a block diagram showing the configuration of the user terminal 50. The user terminal 50 includes, to fulfill content search functions, a content search requesting unit 51, for outputting a request to the agent server system 10 for a search for preferred content, and a search results reception unit 52, for receiving the search results, as well as, for content downloading functions, a content download requesting unit 53, for outputting a content downloading request to the content provider system 30, and a content reception unit 54, for receiving content supplied by the content provider system 30 upon its reception of the downloading request. When downloading targeted content, the user terminal 50 downloads it directly from the content provider system 30, the site that owns the pertinent content. A user can select an arbitrary file form; however, if the file formatting is changed following the embedding of the content ID, it may be that the content ID embedded at the header will be erased and only a content ID that serves as an electronic watermark will be maintained.

The user terminal 50 often further includes: a reproduction device (reproduction software) 55 having a content ID detection function; an ID detection compatible player downloading unit 56, for downloading the reproduction software 55; a content ID notification unit 57; a user ID notification unit 58; and an advertisement and/or other content data reception unit 59, for receiving advertisement and/or other content data from the advertiser system 70. The content, which is downloaded by the content reception unit 54, is reproduced by the reproduction software 55. In this embodiment, a digital content can be read by using a conventional player, but the content ID can not be identified. This is because while taking into account the convenience of users, no limitation is placed on the file formats. To encourage the downloading of the reproduction software 55, it is preferable that valid effects/incentives be provided as the result of downloading a new player. For example, if a priority right for obtaining a ticket to a concert given by a famous musician is provided users who download the reproduction software 55, this is an effective method for promoting the spread and the use of the software. The content ID, which is detected by the reproduction software 55 that is thus provided for the user terminal 50, is transmitted to the agent server system 10 by the content ID notification unit 57, while the user ID notification unit 58 employs a cookie, for example, to transmit a user ID to the agent server system 10. Thereafter, based on the information transmitted by the content ID notification unit 57 and the user ID notification unit 58, the advertisement and/or other content data reception unit 59 obtains advertisement and/or other content data from the advertiser system 70.

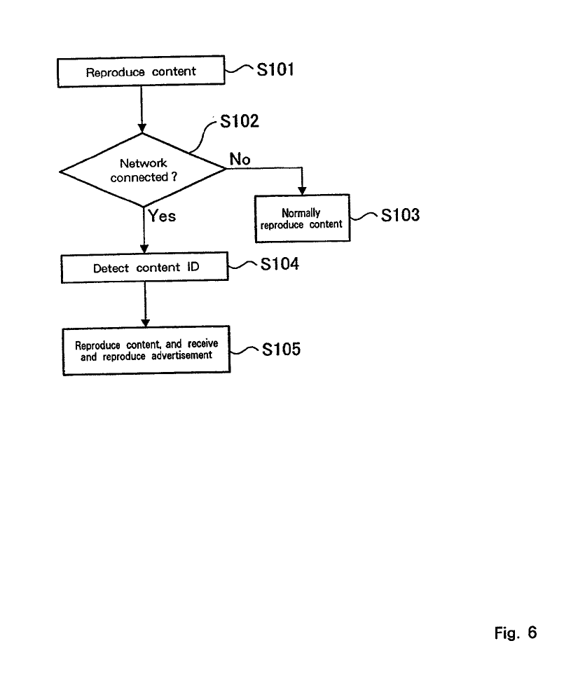

FIG. 6 is an example of a flowchart showing the processing performed by the reproduction device (reproduction software) 55 that includes the content ID detection function. First, the reproduction software 55 reproduces content that is received and downloaded by the content reception unit 54 (step 101). Then, a check is performed to determine whether the user terminal 50 is connected via a network (step 102). If the user terminal 50 is not connected, the normal reproduction of the content is performed (step 103). Whereas if the user terminal 50 is connected, the content ID embedded in the content is detected (step 104) and the detected content ID is uploaded to the agent server system 10 connected via the network. A specific method is provided for the use of an agent (Aglet) to transit the content ID and the address of a user. The agent server system 10 refers to the internal advertisement and/or other content ledger DB 12, and transmits a trigger to the site of the advertiser system 70, and if the user terminal 50 is not connected via the network, prevention of the reproduction of the content does not occur. Thereafter, an advertisement and/or other content obtained by the advertisement and/or other content data reception unit 59 is received, and the advertisement and/or other content, received in a pop-up window, for example, is reproduced, together with the content (step 105). These data are displayed on the screen of a portable telephone or a PDA.

In this embodiment, as is described above, an advertisement and/or other content is tied to content, and a discount coupon, for example, can be distributed for a CD that is sold at a shop and is related to the content. When such an attractive “premium” is attached as an advertisement and/or other content, the inclination of a user to delete the link can be removed. Further, the system can be so designed that only information available via the link is set, or that information that is not initially distributed is added later. These are unique points provided by this system.

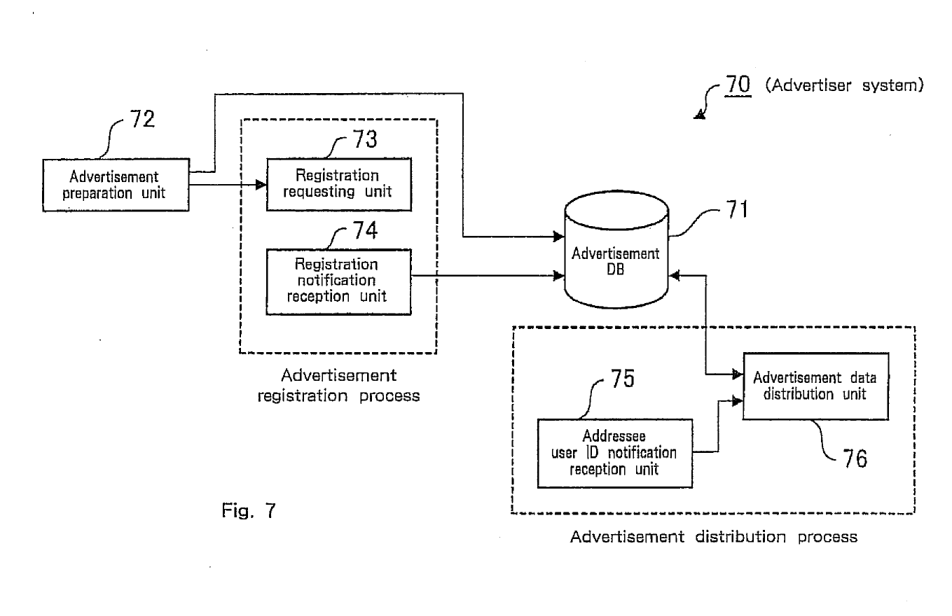

FIG. 7 is an example of a block diagram showing the configuration of the advertiser system 70. The system 70 includes: an advertisement and/or other content preparation unit 72, for preparing an advertisement and/or other content to be displayed on the screen of the user terminal 50; a registration requesting unit 73, for requesting from the agent server system 10 the advertisement and/or other content request or the registration of a site that distributes advertisements and/or other contents; and a registration notification reception unit 74, for receiving information indicating that a site is registered with the agent server system 10. An advertisement and/or other content prepared by the advertisement and/or other content preparation unit 72 is stored in the advertisement and/or other content DB 71, together with information received by the registration notification reception unit 74. The advertiser system 70 further includes, to fulfill the advertisement and/or other content distribution functions, an addressee user ID notification reception unit 75 for receiving, from the agent server system 10, an advertisement and/or other content distribution address, such as an ID address or a user ID; and an advertisement and/or other content data distribution unit 76 for the distribution to the user terminal 50, based on the received advertisement and/or other content distribution address, of an advertisement and/or other content stored in the advertisement and/or other content DB 71. Although not shown, in accordance with the advertisement and/or other content fee payment process, a bill including a charge calculated using the reproduction count is received from the agent server system 10, and payment of the advertisement and/or other content fee is performed based on the bill.

The advertisement and/or other content prepared by the advertisement and/or other content preparation unit 72 is displayed, as is a panel type banner, on the PC screen of the user terminal 50 of a user or on the screen of a net connected terminal, such as a portable telephone or a PDA. A pop-up screen may be employed for a display, and a Java applet form may be employed as a display form. The advertisement and/or other content is transmitted by “Push” to a designated IP address that is received by the addressee user ID notification reception unit 75; however, the guidelines and specifications for the preparation of an advertisement and/or other content can be designated and disclosed by a predetermined service provider (not shown). Further, the provision of preparation tools and preparation agent services can use as the basis for the establishment of a business.

As is described above, according to the model in this embodiment, an address is received from a user who distributes an advertisement and/or other content, and the advertisement and/or other content can be updated or changed at an arbitrary time. The advertisement and/or other content can also be updated when an error is found in the advertisement and/or other content or when the advertisement and/or other content are changed, and further information requiring an immediate response, such as the “remaining number of tickets”, can be added. Thus, the problem presented by the possibility that an advertisement and/or other content prepared and distributed several years previously will continue to be reproduced indefinitely can be resolved. In addition, it is possible to distribute different information to each user based on the registered information as needed. For example, information concerning the age and preferences of a user can be acquired from information supplied by the user or can be obtained from a history of the content that the user has frequently accessed, and an advertisement and/or other content that will probably benefit the user can be identified and distributed. Also, advertisement and/or other content information that a user does not desire to receive can be obtained in advance, and can be used to selectively distribute acceptable announcements to the user. In addition, a content provider can use this system for advertising his music, recording or concert. In this case, it would be appropriate that the lowest advertiser or commission fee be paid the agent server system 10.

In this example embodiment, when the system for correlating multimedia content with metadata that relative to the content is externally located, added value can be provided for the content. In this instance, added value may be, for example, the performance of a search using an index, a clipping of a specific scene or a link to relevant information. An advertisement and/or other content may also be positioned as a type of relevant information. As a result, a user of the content can pay an attention to the advertisement and/or other content information naturally, and the uncomfortable feeling often engendered by an advertisement and/or other content can be reduced. That is, so long as a service using metadata is satisfactory, the interest in metadata occurs automatically, so that there is a high probability that an advertisement and/or other content will draw the attention of a user.

In this embodiment, the property of explosively spreading media can be aggressively used for a business, such as an advertising business. That is, the size of the potential audience for advertisements and/or other contents can be actively increased by redistributing such as downloading or coping, while users at end terminals can legally enjoy free content, business owners can avail themselves of opportunities to expand sales through advertisements and/or other contents, and copyright holders can collect fees for the distribution of content. Therefore, business and culture can be mutually and safely developed, while the current random and illegal copying and the current electronic distribution system, which is not easy to use because of the due to the use of excessively ponderous protection mechanisms, can be eliminated. Moreover, the system of this embodiment, in addition to file downloading, can also be used for moving picture content, and for streaming distribution.

Whether or not the system of this embodiment is widely employed depends in great part on how widespread is the mounting of the reproduction player reproduction software 55. As is described above, the provision of incentives is one method by which new players can be encourage to download the new player. Another is a method, for example, whereby content having low image or low tone quality or that is incomplete is provided first, and when a search for a content ID is initiated by the reproduction software 55, the advertiser system 70 distributes content having high image or tone quality to which advertisement and/or other content information has been added. As an additional method, sample content may be provided first, and when a search for a content ID is requested by the reproduction software 55, complete, corresponding content may be provided by the advertiser system 70. Thereafter, for example, when a difference between the first content and content that can next be provided is transmitted with an advertisement and/or other content, the downloading of the reproduction software 55 will be performed frequently and widespread use of it will ensue.

In this embodiment, as is described above, an advertisement and/or other content to be introduced using the same content, or the effective period of time an advertisement and/or other content is to be used can be flexibly set. Further, the contribution provided by content when used as an advertisement and/or other content medium can be evaluated by conducting an inquiry. And thus, a specific basis (the actual profit accrued) can be established for the calculation of a charge for the services rendered an advertiser, and compensation consonant with the contribution made by the content can be distributed to the content provider. Furthermore, since a content ID is embedded as an electronic watermark in the content that is used, the same service can be provided by content whose format has been changed, without having to depend on a specific format. In addition, since the preferences of users at advertisement and/or other content distribution addresses can, to a degree, be deduced, advertisements and/or other contents that are judged appropriate for such users can be distributed, and the effects produced by the advertisements and/or other contents improved.

In this example embodiment, the data to be distributed has been that which use advertisements. However, not only general advertisement and/or other content information, but also additional information corresponding to a content ID can be provided for a user terminal 50. For example, a portion of content may be intentionally separated, and based on the content ID, the remaining content, which is additional information provided by a predetermined site, and the content is completed by the user terminal 50. Further, as additional information, content having a high image or tone quality may be distributed. That is, additional information that is provided to increase resolution or tone quality may be provided by a site based on the content ID that serves as an identifier.

Thus, as is described above, according to the present invention, the property of explosively spreading media can be used for a business, such as an advertising business.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and run, controls the computer system such that it carries out the methods described herein. The present invention can also be embedded in a computer program product, which comprises all the features enabling the implementation of the functions and/or methods described herein, and which—when loaded in a computer system—is able to carry out these methods and/or functions.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing any function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. An advertisement distribution system comprising:
a content provider system, for providing for a user terminal a content to which an identifier has been added;
a user terminal, for receiving said content, via a network, from said content provider system, and for identifying and outputting, to said network, said identifier added to said content; and
an advertisement provider system, for the distribution to said user terminal, based on said identifier output by said user terminal, of a predetermined advertisement via said network.

2. The advertisement distribution system according to claim 1, further comprising:
an agent server system, for managing said identifier added to said content,
wherein said agent server system employs said identifier, output by said user terminal, to transmit an advertisement distribution trigger to said advertisement provider system for the distribution of said predetermined advertisement.

3. An advertisement distribution management system, which is connected to a user terminal connected to a network and which manages the distribution of an advertisement to a user terminal, comprising:
an advertisement ledger database, for the storage therein of a list to which content used as an advertisement medium and information concerning an advertisement distribution site for disseminating said advertisement when said content is reproduced;
reception means, for receiving a content ID output by said user terminal when said content is reproduced;
search means, for performing a search, based on said content ID, of said advertisement ledger database for said predetermined advertisement distribution site; and
notification means, for issuing to said advertisement distribution site, when found, an advertisement distribution request.

4. The advertisement distribution/management system according to claim 3, wherein said reception means receives address information for said user terminal, and said notification means transmits the address information to said advertisement distribution site.

5. A content provider system, which is connected to a user terminal via a network and which provides a content for said user terminal, comprising:
storage means, for storing pertinent content and a corresponding content ID for identifying said pertinent content;
reception means, for receiving a content download request from said user terminal; and
content provision means, for reading, based on said content downloading request, said pertinent content and said corresponding content ID from said storage means, and for providing for said user terminal said pertinent content and said content ID.

6. The content provider system according to claim 5, wherein said storage means is used to store a content with a content ID being embedded.

7. The content provider system according to claim 5, further comprising:
registration request output means, for outputting a registration request to an agent server that manages a content ID; and
content ID reception means, for receiving, based on said registration request, said content ID from said agent server.

8. A user terminal comprising:
content reproduction means, for reproducing content wherein a content ID has been embedded;
detection means, for detecting said embedded content ID when said content is to be reproduced;
notification means, for transmitting said detected content ID to a predetermined server via a network; and
additional information reception means for receiving from a predetermined additional information distribution site, via a network, additional information corresponding to said content ID.

9. The user terminal according to claim 8, wherein, before reproduction of said content, said content reproduction means outputs said additional information received by said additional information reception means.

10. The user terminal according to claim 8, further comprising:
content search means, for searching, via a network, for preferred content in a predetermined server; and
downloading means, for downloading, as a search result obtained by said content search means, content in which said content ID is embedded.

11. An advertisement distributor system comprising:
registration request output means, for outputting an advertisement registration request to an agent server system that manages an identifier included in predetermined content;
address information reception means, for receiving address information for a user terminal that reproduces content; and
advertisement data distribution means, for distributing advertisement data that is output to said user terminal for content reproduction.

12. The advertisement distributor system according to claim 11, further comprising:
bill reception means, for receiving from said agent server system a bill corresponding to the frequency whereat content is reproduced; and
advertisement fee payment means, for paying an advertisement fee in accordance with said bill.

13. A content reproduction program that permits a computer, for reproduction of content in which a content ID is embedded, to perform:
a function for detecting said content ID embedded in said content;
a function for transmitting said content ID via a network; and
a function for, before content reproduction, outputting advertisement data, based on said content ID, that has been received via said network.

14. The content reproduction program according to claim 13, wherein said function for outputting said advertisement data that is received displays an advertisement, interacting with the reproduction of said content.

15. A storage medium on which a computer stores a computer-readable program that permits said computer to perform:
a process for, before content reproduction, detecting said content ID embedded in said content;
a process for transmitting said content ID via a network; and
a process for outputting additional information, based on said content ID, that are received via a network, while interacting with said content reproduction.

16. An additional information distribution method comprising the steps of:
providing an identifier for digital content to identify said digital content;
detecting said identifier before reproduction of said digital content to which said identifier is added;
transmitting said detected identifier, together with user terminal information, to a network; and
distributing predetermined additional information to said user terminal based on said identifier that is transmitted.

17. The additional information distribution method according to claim 16, wherein said predetermined additional information to be distributed is an advertisement that corresponds to said digital content.

18. The additional information distribution method according to claim 17, further comprising the steps of:
counting said identifiers transmitted to said network; and
charging an advertisement distributor in accordance with the number of advertisements that are distributed.

19. A content distribution system comprising:
a content provider system, for providing for a user terminal a content to which an identifier has been added;
a user terminal, for receiving said content, via a network, from said content provider system, and for identifying and outputting, to said network, said identifier added to said content; and
an content provider system, for the distribution to said user terminal, based on said identifier output by said user terminal, of predetermined content via said network.

20. A method comprising steps to implement the functions of the content distribution system of claim 19.

21. A method comprising steps to implement the functions of the advertisement distribution management system of claim 3.

22. A method comprising steps to implement the functions of the content provider system of claim 5.

23. A method comprising steps to implement the functions of the user terminal of claim 8.

24. A method comprising steps to implement the functions of the advertisement distributer system of claim 11.

25. An article of manufacture comprising a computer usable medium having computer readable program code means embodied therein for causing content distribution, the computer readable program code means in said article of manufacture comprising computer readable program code means for causing a computer to effect the steps of claim 20.

26. A computer program product comprising a computer usable medium having computer readable program code means embodied therein for causing advertisement distribution, the computer readable program code means in said computer program product comprising computer readable program code means for causing a computer to effect the functions of claim 1.

27. A computer program product comprising a computer usable medium having computer readable program code means embodied therein for causing content provision, the computer readable program code means in said computer program product comprising computer readable program code means for causing a computer to effect the functions of claim 5.

28. A computer program product comprising a computer usable medium having computer readable program code means embodied therein for causing content advertisement distribution, the computer readable program code means in said computer program product comprising computer readable program code means for causing a computer to effect the functions of claim 11.
